(19) United States
(12) Patent Application Publication
(10) Pub. No.: US 2018/0324299 A1
(43) Pub. Date: Nov. 8, 2018

(54) NETWORK-CONTROLLED ROBOCALL AND SCAM CALL HANDLING

(71) Applicant: T-Mobile USA, Inc., Bellevue, WA (US)

(72) Inventors: Muhammad Ejaz Sial, Snoqualmie, WA (US); Shujaur Mufti, Snoqualmie, WA (US); Zeeshan Jahangir, Bellevue, WA (US)

(21) Appl. No.: 15/863,562

(22) Filed: Jan. 5, 2018

Related U.S. Application Data
(60) Provisional application No. 62/503,229, filed on May 8, 2017.

(51) Int. Cl. H04M 3/436; H04W 4/16; H04M 3/54

(52) U.S. Cl. CPC H04M 3/436; H04M 3/543; H04W 4/16

(57) ABSTRACT

Systems and methods for network-controlled scam/robocall handling are described. When an incoming call destined for a user device is detected, if the user device is subscribed to network-controlled scam/robocall handling, the incoming call is handled at the network according to the subscription. If user preferences are specified, the call may be blocked, forwarded to another number, sent directly to voice mail, or delivered to the device. How a call is handled may be determined based on a category associated with an originating number of the incoming call.

### CROSS-REFERENCE TO RELATED APPLICATIONS

This application is a non-provisional application of, and claims priority to and the benefit of, U.S. Provisional Patent Application Ser. No. 62/503,229, filed May 8, 2017, and entitled “Phone Number Blocking,” the entirety of which is incorporated herein by reference.

### BACKGROUND

Scam calls and Robocalls, which may include pre-recorded and/or autodialed calls, are unwelcome to many mobile device users. While user-defined call blocking using OEM native features can be used to block calls from known numbers, most scam calls or robocalls originate from numbers not previously known to the recipient.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a pictorial diagram of an example communication network configured to implement network-controlled scam/robocall handling.

FIG. 2 is a pictorial diagram of an example user interface configured to receive user preferences associated with a subscription to network-controlled Scam/Robocall handling.

FIG. 3 is a block diagram of select components of an example user device.

FIG. 4 is a block diagram of select components of an example communication network system configured to implement network-controlled scam/robocall handling.

FIG. 5 is a flow diagram of an example process for providing network-controlled robocall blocking.

FIG. 6 is a flow diagram of an example process for providing network-controlled scam/robocall handling.

FIG. 7 is a flow diagram of an example process for handling a call, at the network, according to pre-specified user preferences.

### DETAILED DESCRIPTION

### Introduction

Systems and methods discussed herein are directed to handling scam and robocalls at the network level.

In the described example implementations, individual users can subscribe to a robocall blocking service offered by the communications network. If the user is subscribed to the robocall blocking service, when the network receives a call destined for the user, the network first checks to see if the call is originating from a known robocaller, scammer, or other defined bad actor. In various example implementations, scam or robocalls may be automatically blocked or may be blocked or otherwise handled based on user-specified preferences. For example, if a user specifies that all robocalls are to be blocked, if it is determined that an incoming call is from a known bad actor, then the call is blocked. As another example, a user may specify particular ways in which a call is to be handled, depending on a category with which the originating number is associated. For example, the user may choose to send political calls to a voicemail, but block calls from telemarketers.

Blocking calls at the network level benefits the user in that unwanted calls received at the user device are reduced. Furthermore, use of network resources and device resources is reduced. For example, network bandwidth is not used to deliver calls that are known to be unwanted by the user. On the device, radio resource utilization and battery utilization are improved. For example, in the case of an Internet of Things (IoT) device, if the device is in an idle mode, it will not switch to an active mode to receive unwanted scam or robocalls. Accordingly, battery life will improve.

### Example Network Environment

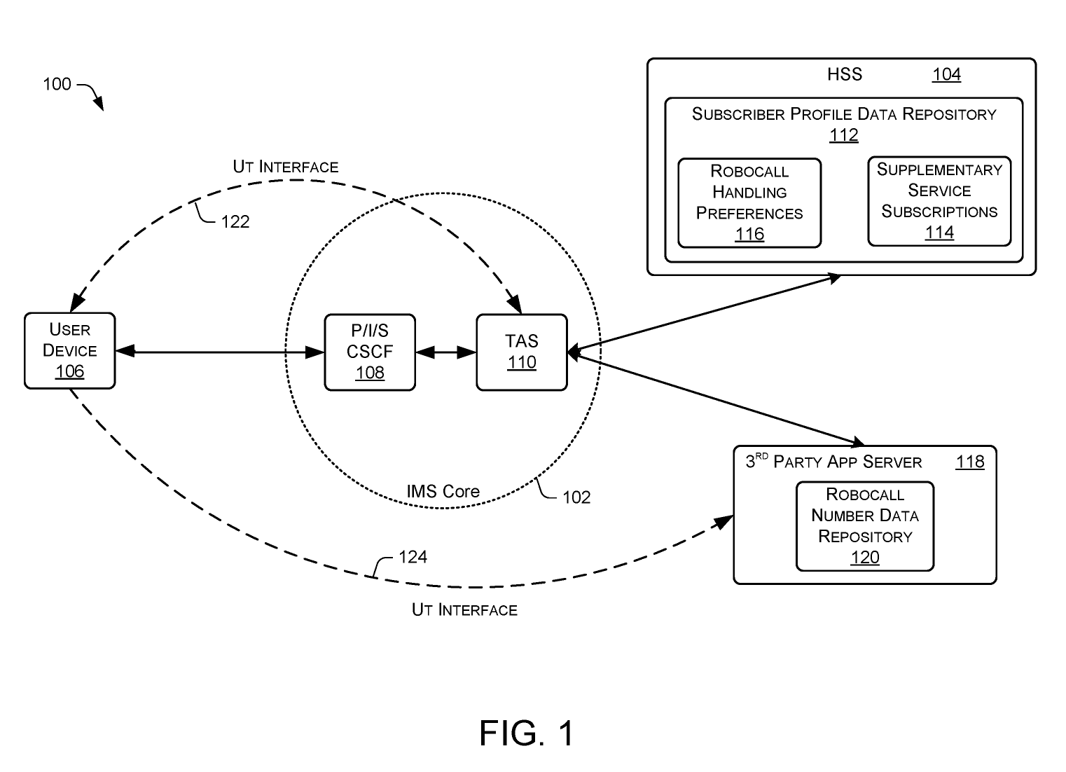

FIG. 1 illustrates an example network environment 100 in which network-controlled robocall and scam call handling can be implemented. Example network environment 100 includes IMS (IP multimedia subsystem) core 102, HSS (home subscriber server) 104, and one or more user devices 106. IMS core 102 includes CSCF (call session control function)108, which may include, for example, a proxy CSCF, an interrogating CSCF, and serving CSCF. IMS core 102 also includes TAS (telephony application server) 110. HSS 104 includes subscriber profile data repository 112. Network environment 100 may also include one or more third-party application servers 118. In an example, a third-party application server 118 may include a robocall number data repository 120, which stores a list of known bad-actor phone numbers. Additionally, or alternatively, all or a portion of subscriber profile data repository 112 may be maintained on a third-party application server. In an alternate example implementation, subscriber profile data repository 112, or portions thereof, and/or robocall number data repository 120, or portions thereof may be implemented as part of TAS 110, HSS 104, and/or third party app server 118.

When user device 106 connects to the network, TAS 110 authenticates the user device and accesses the subscriber profile data repository 112 to access a user profile associated with the user device. Subscriber profile data repository 112 includes supplementary service subscriptions 114, enabling TAS 110 to determine any supplementary services to which the user device is subscribed. If the user is subscribed to robocall handling, particular robocall handling preferences may be stored in robocall handling preferences 116.

When IMS core 102 receives a call directed to user device 106, e.g., as a session initiation protocol (SIP) invite, the TAS 110 determines whether or not the user device to which the call is directed is subscribed to robocall handling. If the user device is subscribed to robocall handling, then the TAS compares the originating number associated with the call to a list of known bad actors. For example, TAS searches the robocall number data repository 120 for the originating number by checking a local database, or initiating an API to an external database or a third-party service. If the originating number is found in the robocall number data repository 120, the TAS blocks the call, or otherwise handles the call according to user preferences.

For example, if the user profile includes robocall handling preferences for one or more categories, the TAS determines a category associated with the originating number. In an example implementation, robocall number data repository 120 includes a list of numbers and a corresponding category for each number. The user preference for the determined category is determined according to the robocall handling preferences 116 for the user device 106. The TAS then handles the call according to the specified preferences for the determined category, to, for example, block the call, send the call to voicemail, forward the call to another number, or deliver the call.

In the illustrated example, to subscribe to robocall handling, user device 106 sends a message over the Ut interface 122 using XCAP (XML configuration access protocol) to TAS 110. The message indicates the user's desire to subscribe to robocall handling. The message may also indicate specific user preferences for handing different categories of scam/robocalls. Upon receiving the message via the Ut interface 122, the TAS 110 saves the robocall subscription and the user preferences to the subscriber profile data repository 112. In alternate example implementations, rather than sending a message over the Ut interface, user device 106 may communicate the information using a customized client application, a web portal, or USSD (unstructured supplementary service data) codes.

In an example implementation, a user may also identify a number as a scam or robocall. For example, if a user receives a call that appears to be a scam or robocall, user device 106 may send a message over Ut interface 122 to the TAS, to be forwarded to the third-party application server 118. Alternatively, the user device 106 may send the message over Ut interface 124 directly to the third-party application server 118. In alternate example implementations, rather than sending a message over the Ut interface, user device 106 may report a number as a scam or robocall number using a customized client application, a web portal, or USSD (unstructured supplementary service data) codes.

Upon receiving the message, the reported number may be added to the robocall number data repository.

User device 106 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the user device 106 as being “mobile,” (i.e., configured to be carried and moved around) it is to be appreciated that the user device 106 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile device,” “computing device,” and “user equipment (UE)” may be used interchangeably herein to describe any communication device capable of performing the techniques described herein. Furthermore, the user device 106 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), 5G, IEEE 802.1x protocols, WiMAX, Wi-Fi, and/or any future IP-based network technology or evolution of an existing IP-based network technology.

### Example User Interface

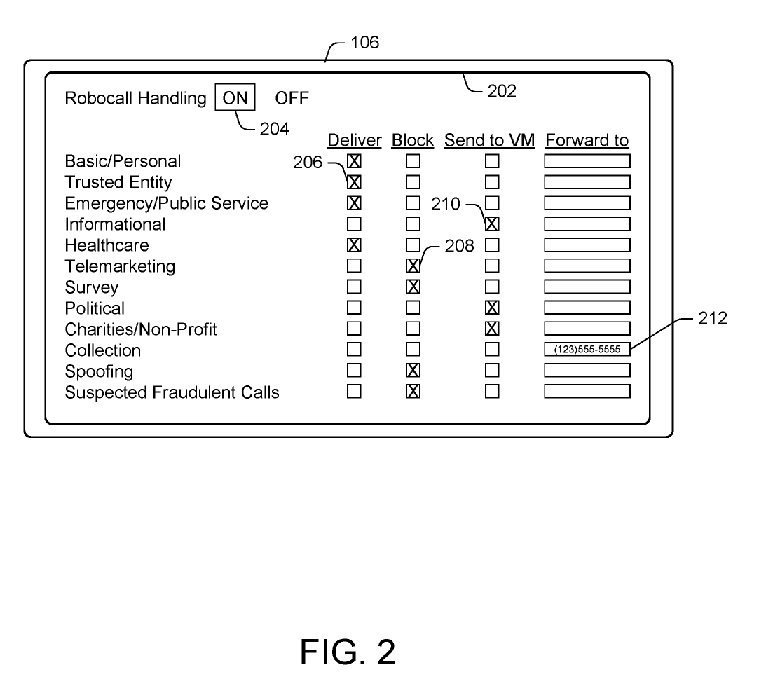

FIG. 2 illustrates an example user interface 202 on user device 106 through which a user can specify call handling preferences. For example, when robocall handling is turned on 204, for each call category, the user can specify whether the call is to be delivered 206, blocked 208, sent to voicemail 210, or forwarded to another number 212. Categories may be defined by legal/standard bodies, such as the FCC (Federal Communications Commission) and/or ATIS (Alliance for Telecommunications Industry Solutions). Table 1, below provides a list of example call categories specified by the FCC/ATIS for which handling preferences can be specified. Additional categories may be defined by a service provider for various business purposes. Alternate implementations may include more, fewer, or different categories as business needs change and/or categories are changed by these or other legal/standards bodies.

TABLE 1

| Category | Description |
|---|---|
| Telemarketing | Call originated in order to induce the end user to |
| | purchase a product or service. |
| Survey | Call originated to collect data/opinions from an end |
| | user. |
| Political | Call originated with the intent to deliver a political |
| | message to the end user. |
| Charities/Non- | Call originated from a non-profit company with the |
| Profit | intent to inform or solicit information and/or money |
| | from the end user. |
| Informational | Call originated from an entity with whom the end |
| | user has an established business relationship. The |
| | call is intended to inform the end user regarding an |
| | established business transaction such as package |
| | delivery, appointment reminder, order confirmation, |
| | conferencing, etc. |
| Emergency/Public | Call originated from an entity that is delivering an |
| Service | emergency or public service type call. |
| Collection | Call originated from a company with the intent to |
| | collect outstanding funds from the end user. |
| Healthcare | Call originated from a company with the intent to |
| | provide healthcare information to the end user, such |
| | as doctors, nurses, insurance companies, etc. |
| Basic/Personal | Call originated from a party that just wants to speak |
| | personally with the end user. |
| Trusted Entity | Call originated from a trusted entity whose calling |
| | patterns such as conferencing or messaging can be |
| | covered by the listed calling categories but they are |
| | an established trusted source. |
| Spoofing | Possible spoofed called ID. |
| Suspected Fraud- | Suspected fraudulent call. |
| ulent Calls | |

In the example illustrated in FIG. 2, a user has specified that basic/personal calls, trusted entity calls, emergency/public service calls, and healthcare calls are all to be delivered with no special handling. Telemarketing calls, survey calls, spoofing calls, and suspected fraudulent calls are all to be blocked. Informational, political, and charity/non-profit calls are to be sent directly to voicemail, and collection calls are to be forwarded to a different number.

### Example User Device

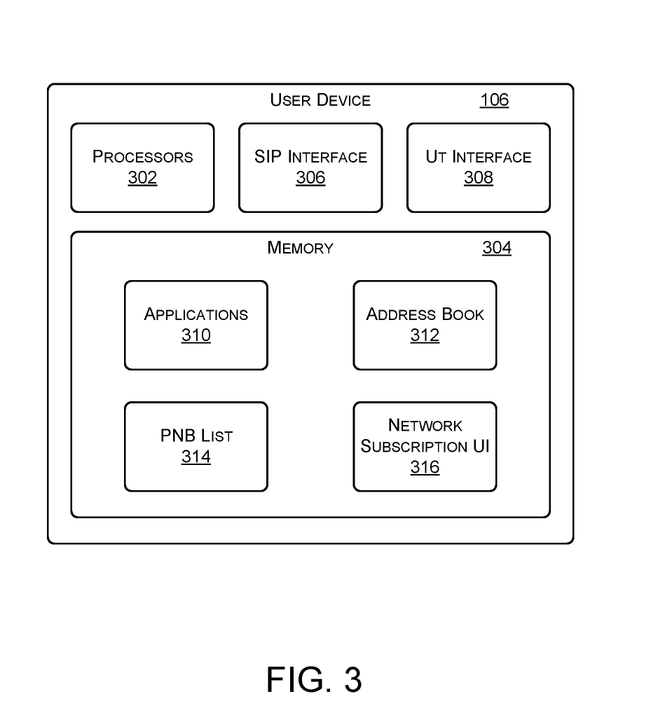

FIG. 3 illustrates select components of an example user device 106. Example user device 106 includes one or more processors 302, memory 304 communicatively coupled to the one or more processors 302, SIP interface 306, and Ut interface 308. Memory 304 may include, for example, any number of applications 310, an address book 312, a personal number blocking (PNB) list 314, and a network subscription user interface 316.

SIP interface 306 enables user device 106 to communicate with the network via the session initiation protocol (SIP). Ut interface 308 enables user device 106 to communicate directly to the TAS 110 or a third-party application server 118 via XCAP. Enhancements to the Ut interface will support the additional Ut interface communications described herein.

Applications 310 may include any number of applications for execution by the processor 302. Examples may include games, Internet browsers, social media applications, music applications, and so on. Address book 312 is configured to store names, phone numbers, addresses, etc. associated with any number of contacts. PNB list 314 is configured to store a white list of numbers that are trusted by the user of the user device 106 and/or a black list of numbers that the user has chosen to block. In an example implementation, when user device 106 receives a call, the user device compares the originating number to numbers on the black list and/or white list stored on the user device, and handles the call accordingly. For example, calls originating from black list numbers may be terminated prior to the user device ringing or otherwise indicating the incoming call.

Network subscription user interface 316 provides a graphical user interface that allows a user of user device 106 to subscribe to or unsubscribe from any number of supplementary services. Communication networks may provide any number of supplementary services, examples of which may include, call forwarding, barring all incoming calls, barring all outgoing calls, call hold, call waiting, etc. Such supplementary services also include network-controlled scam/robocall handling as described herein. The example user interface shown in FIG. 2 is an example of a portion of an example network subscription user interface 316.

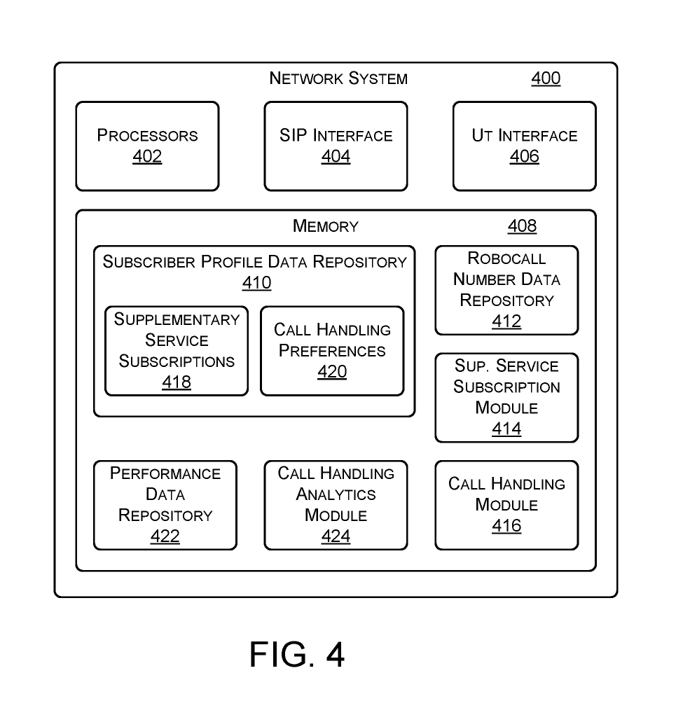

FIG. 4 illustrates select components of a communication network system 400 configured to implement network-controlled scam/robocall handling as described herein. Example network system 400 includes one or more processors 402, SIP interface 404, Ut interface 406, and memory 408 communicatively coupled to the one or more processors 402. Memory 408 may include, for example, subscriber profile data repository 410, robocall number data repository 412, supplementary service subscription module 414, and call handling module 416. Subscriber profile data repository 410 includes supplementary service subscriptions 418 and call handling preferences 420. Memory 408 may also include performance data repository 422 and call handling analytics module 424. The example components shown in FIG. 4 may be implemented on a single server or may be distributed across multiple servers that are communicatively coupled one to another. Furthermore, individual components may be implemented on a third-party application server.

SIP interface 404 enables network system 400 to communicate with other system components (e.g., user devices) via the session initiation protocol (SIP). Ut interface 406 enables network system 400 to communicate with other system components (e.g., user devices) via XCAP.

Subscriber profile data repository 410 maintains user profile data for user devices associated with the network system 400. User profile data may include, for example, user name, phone number, user device ID, billing data, and so on. In addition, subscriber profile data repository includes supplementary service subscriptions 418, which maintains a list of supplementary services to which a user device is subscribed. If a user device is subscribed to scam/robocall handling as described herein, the subscriber profile data repository 410 may also include call handling preferences 420. Call handling preferences 420 includes user-specified preferences for various categories of incoming calls.

Robocall number data repository 412 maintains a list of numbers that are known to be associated with scams, robocalls, or other defined bad actors.

Supplementary service subscription module 414 is configured to manage subscriber subscriptions. For example, supplementary service subscription module 414 receives requests from user devices to add or remove supplementary service subscriptions. In response to those requests, supplementary service subscription module 414 updates the supplementary service subscriptions 418 and call handling preferences 420 in subscriber profile data repository 410.

Call handling module 416 is configured to handle and incoming call according to user subscriptions and user preferences. For example, when an incoming call is received by the network system 400, call handling module 414 determines whether or not the user device to which the call is destined is subscribed to robocall handling. If the user device is subscribed to robocall handling, the call may be blocked, or otherwise handled according to a category associated with the originating number and user preferences for that category.

Performance data repository 422 maintains data that describes how calls that are identified as scam or robocalls are handled. For example, data may be saved to performance data repository 422 that identifies, for each call that is identified as a scam or robocall, a call date/time, an originating number, a destination number, a category, and an indication of how the call was handled.

Call handling analytics module 424 may be configured to provide access to data stored in the performance data repository 422. For example, a service provider may use call handling analytics module 424 to analyze and track how many scam/robocalls are received in a given time period, associated with a particular category, and to view how those different calls were being handled. Similarly, a user device may be given access to similar data via, for example, a custom application or API call, to view data identifying how many scam/robocalls were detected and handled for a particular destination number associated with the user device.

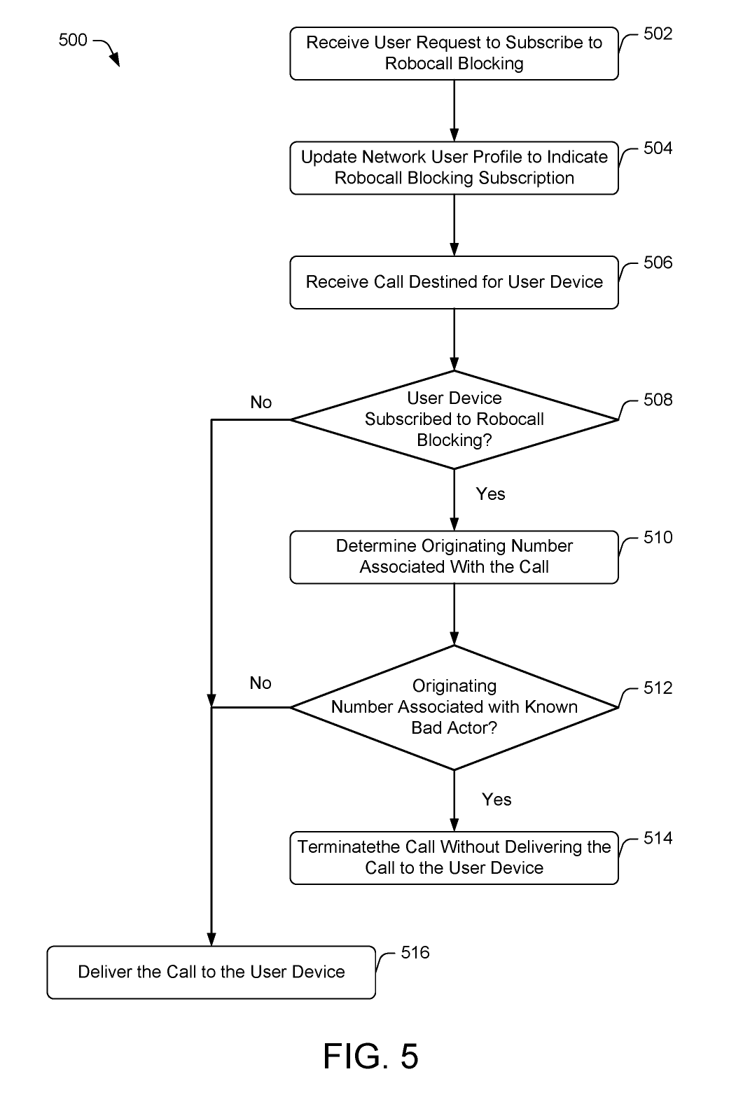

FIG. 5 is a flow chart of an example process 500 for providing network-controlled robocall blocking.

At block 502, a request to subscribe to robocall blocking is received. For example TAS 110 receives an XCAP request from user device 106, requesting to subscribe the user device 106 to network-controlled robocall blocking.

At block 504, a network user profile is updated to indicate the requested robocall blocking subscription. For example, TAS 110 communicates with HSS 104 to add an entry to supplementary service subscriptions 114 indicating that user device 106 is subscribed to the requested network-controlled robocall blocking.

At block 506, a call destined for the user device is received. For example, IMS core 102 receives a call for which user device 106 is the intended recipient.

At block 508, it is determined whether or not the user device is subscribed to robocall blocking. For example, TAS 110 communicates with HSS 104 to determine the supplementary service to which the user device is subscribed. In an example, this may be done during an initial registration when the user device is powered on and connected to the communication network. If the user device is not subscribed to robocall blocking (the “No” branch from block 508, then processing continues as described above with regard to block 516.

If the user device is subscribed to robocall blocking (the “Yes” branch from block 508), then at block 510, an originating number associated with the call is determined. For example, TAS 110 extracts an originating number from a SIP header of an incoming SIP invite message that defines the call.

At block 512, it is determined whether or not the originating number is associated with a known bad actor (e.g., a scam or robocall). For example, TAS 110 initiates an API call to the robocall number data repository 120, requesting data associated with the originating number associated with the received call.

If the originating number is located in the robocall number data repository (the “Yes” branch from block 512), then at block 514, TAS 110 terminates the call without delivering the call the user device 106.

On the other hand, if the originating number is not found in the robocall number data repository (the “No” branch from block 512), then at block 516, the call is delivered, through the S-CSCF 108, to the user device 106.

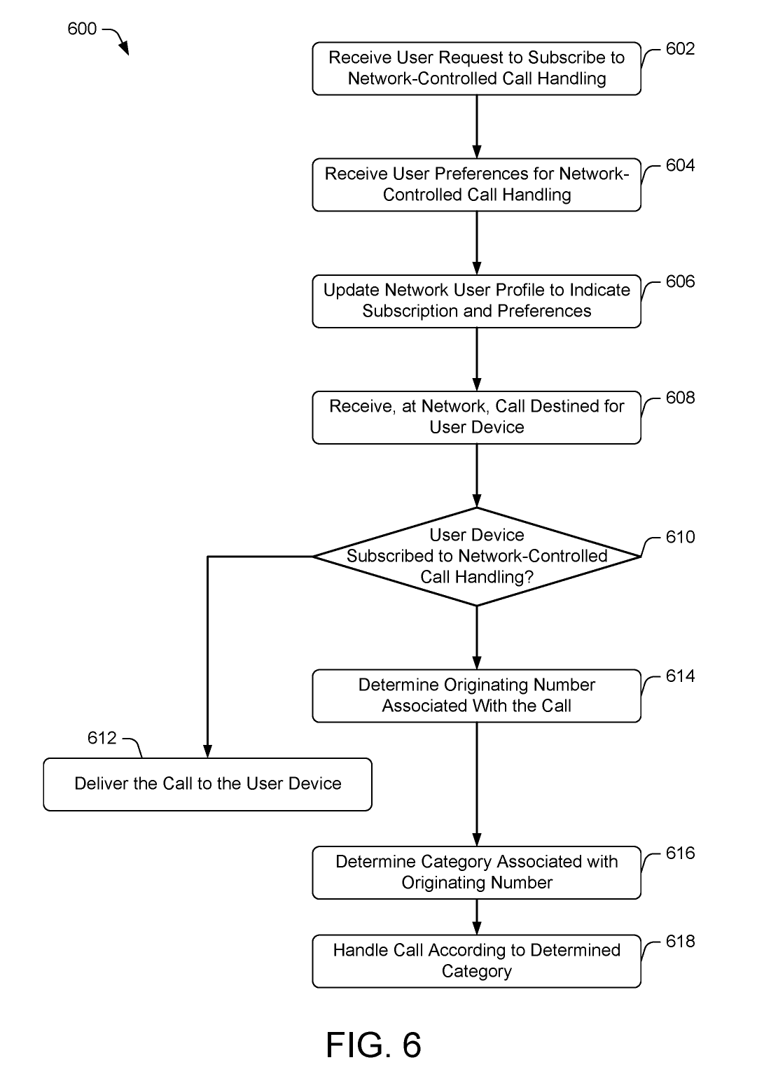

FIG. 6 is a flow chart of an example process 600 for providing network-controlled scam/robocall handling.

At block 602, a request to subscribe to network-controlled call handling is received. For example, supplementary service subscription module 414 receives, from a user device, an XCAP request to subscribe to network-controlled call handling.

At block 604, user preferences for network-controlled call handling are received. For example, the received XCAP request may include user preferences for various categories of incoming calls.

At block 606, a network user profile is updated to indicate the subscription and preferences. For example, supplementary service subscription module 414 communicates with subscriber profile data repository 410 to add robocall handling to the supplementary service subscriptions 418 for the user associated with the received request. If user preferences were specified, supplementary service subscription module 414 also communicates with subscriber profile data repository 410 to add the user preferences to call handling preferences 420.

At block 608, a call destined for the user device is received at the network. For example, an incoming call is received via the SIP interface 404.

At block 610, it is determined whether or not the user device is subscribed to network-controlled call handling. For example, TAS 110 communicates with HSS 104 to determine the supplementary service to which the user device is subscribed. In an example, this may be done during an initial registration when the user device is powered on and connected to the communication network. If the user device is not subscribed to network-controlled call handling (the “No” branch from block 610, then at block 612, the call is delivered to the user device.

On the other hand, if the user device is subscribed to network-controlled call handling (the “Yes” branch from block 610), then at block 614, an originating number associated with the call is determined. For example, call handling module 416 extracts an originating number from a SIP header of an incoming SIP invite message that defines the call.

At block 616, a category associated with the originating number is determined. For example, call handling module 416 receives data from robocall number data repository that identifies a category associated with the originating number.

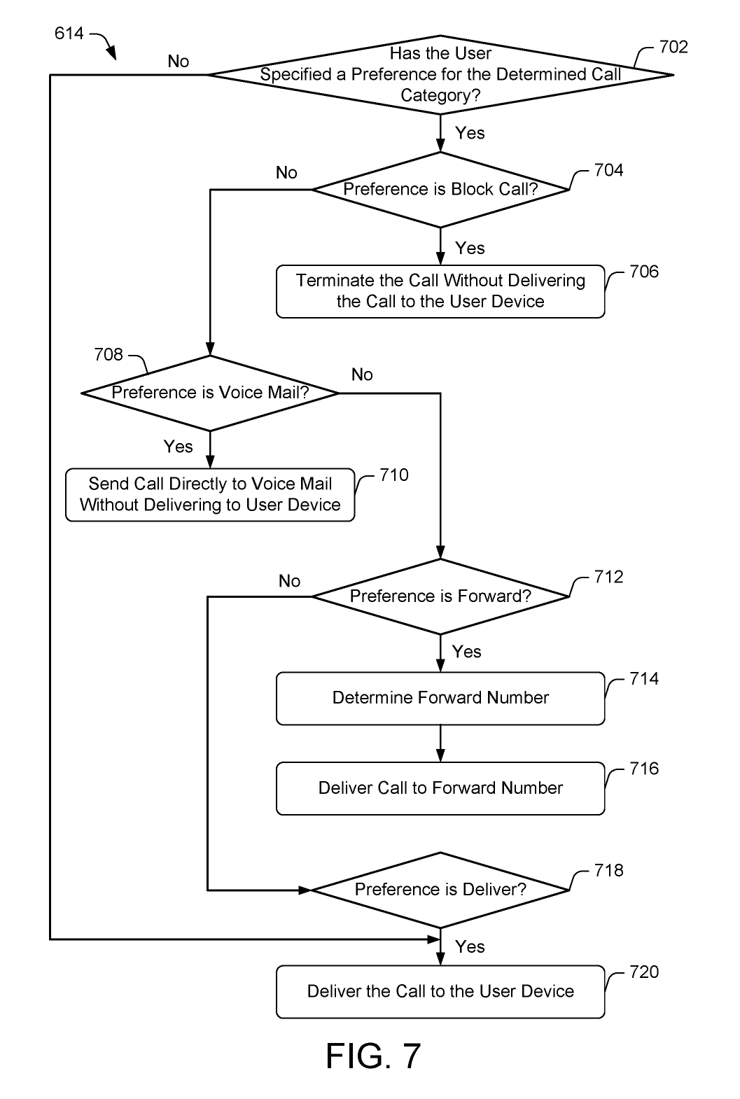

At block 618, the call is handled at the network according to the determined category. For example, call handling module 416 requests data from call handling preferences 420 to determine user preferences for handling calls of the determined category. Specific examples are described in more detail below with regard to FIG. 7.

FIG. 7 is a flow chart of an example process 614 for handling a call, at the network, according to pre-specified user preferences.

At block 702, a determination is made as to whether or not a user has specified a preference for handling a call having the determined call category. For example,

If it is determined that the user has not specified a preference for handling a call having the determined call category (the “No” branch from block 702), then processing continues as describe below with reference to block 720.

On the other hand, if it is determined that the user has specified a preference for handing a call having the determined call category (the “Yes” branch from block 702), then at block 704, a determination is made as to whether or not the user preference is to block the call. For example,

If it is determined that the user preference is to block the call (the “Yes” branch from block 704), then at block 706, the call is terminated without delivering the call to the user device. For example,

On the other hand, if it is determined that the user preference is not to block the call (the “No” branch from block 704), then at block 708, a determination is made as to whether or not the user preference is the send the call directly to voice mail.

If it is determined that the user preference is to send the call directly to voice mail (the “Yes” branch from block 708), then at block 710, the call is sent directly to voice mail without being delivered to the user device. For example,

On the other hand, if it is determined that the user preference is not to send the call to voice mail (the “No” branch from block 708), then at block 712, a determination is made as to whether or not the user preference is to forward the call to another number. For example,

If it is determined that the user preference is to forward the call to another number (the “Yes” branch from block 712), then at block 714, a forward number is determined. For example . . . Then, at block 716, the call is delivered to the forward number. For example.

On the other hand, if it is determined that the user preference is not to forward the call to another number (the “No” branch from block 712), then at block 718 a determination is made as to whether or not the user preference is to deliver the call. If it is determined that the user preference is to deliver the call (the “Yes” branch from block 718), then at block 720, the call is delivered to the user device. For example,

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 304 and memory 408 are examples of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1-7. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method implemented at a communication network, the method comprising:
receiving, at the communication network, a call directed to a particular user device;
determining an originating number associated with the call;
determining, based at least in part on the originating number, that the call is a robocall or a scam call;
based, at least in part, on the determining that the call is a robocall or a scam call, preventing the call from being delivered to the user device.

2. A method as recited in claim 1, further comprising receiving a request to subscribe the user device to network-controlled robocall blocking, wherein:
preventing the call from being delivered to the user device is further based, at least in part, on the request to subscribe the user device to network-controlled robocall blocking.

3. A method as recited in claim 2, wherein receiving the request comprises receiving the request as an extensible markup language configuration access protocol (XCAP) request via a Ut interface.

4. A method as recited in claim 2, further comprising:
in response to receiving the request to subscribe the user device to network-controlled robocall blocking, updating a network user profile to indicate that the user device is subscribed to network-controlled robocall blocking.

5. A method implemented at a communication network, the method comprising:
receiving, at the communication network, a call directed to a particular user device;
determining an originating number associated with the call;
determining, based at least in part on the originating number, a category associated with the call;
determining a user-specified call handling preference associated with the category; and
the communication network handling the call according to the user-specified call handling preference.

6. A method of claim 5, wherein the category associated with the call is selected from a plurality of categories comprising:
basic/personal calls;
trusted entity calls;
emergency/public service calls;
informational calls;
healthcare calls;
telemarketing calls;
survey calls;
political calls;
charity/non-profit calls;
collection calls;
spoofing calls; and
suspected fraudulent calls.

7. A method of claim 5, wherein handling the call according to the user-specified call handling preference comprises terminating the call without delivering the call to the user device.

8. A method of claim 5, wherein handling the call according to the user-specified call handling preference comprises sending the call directly to voice mail without delivering the call to the user device.

9. A method of claim 5, wherein handling the call according to the user-specified call handling preference comprises forwarding the call to another number.

10. A method of claim 5, wherein handling the call according to the user-specified call handling preference comprises delivering the call to the user device.

11. A communication network comprising:
one or more processors;
memory, communicatively coupled to the one or more processors;
a call handling module stored in the memory and executed on the processor, the call handling module configured to:
determine a category associated with an incoming call;
based, at least in part, on the category, handle the incoming call according to one or more user-specified preferences.

12. A communication network as recited in claim 11, wherein the user-specified preferences indicate that the call is to be:
terminated without being delivered to the user device;
forwarded to another number instead of being delivered to the user device; or sent directly to voice mail without being delivered to the user device.

13. A communication network as recited in claim 11, wherein the category associated with the incoming call is selected from a plurality of categories comprising:
basic/personal calls;
trusted entity calls;
emergency/public service calls;
informational calls;
healthcare calls;
telemarketing calls;
survey calls;
political calls;
charity/non-profit calls;
collection calls;
spoofing calls; and
suspected fraudulent calls.

14. A communication network as recited in claim 11, further comprising:
a subscriber profile data repository, the subscriber profile data repository including:
supplementary service subscriptions that indicate, for a particular user device, any number of supplementary service subscriptions to which the user device is subscribed,
wherein:
the user-specified preferences include an indication that a user device to which the incoming call is destined is subscribed to network-controlled scam/robocall handling.

15. A communication network as recited in claim 14, wherein:
the subscriber profile data repository further includes call handling preferences that specify, for one or more call categories, a user preference for how the network is to handle an incoming call associated with a particular category.

16. A communication network as recited in claim 11, further comprising:
a Ut interface for receiving an XCAP request from a user device, the XCAP request indicating that the user device is to requesting to subscribe to network-controlled scam/robocall handling.

17. A communication network as recited in claim 16, wherein the XCAP request further indicates, for one or more categories, a user preference for how an incoming call associated with a particular category is to be handled by the communication network.

18. A communication network as recited in claim 11, further comprising a robocall number data repository configured to store a list of numbers associated with known scams or robocalls.

19. A communication network as recited in claim 18, wherein the robocall number data repository is configured to receive, from a user device, via a Ut interface, an XCAP request to add a number to the robocall number data repository.

20. A communication network as recited in claim 11, further comprising:
a performance data repository configured to store data associated with calls that are identified as scam or robocalls; and
a call handling analytics module configured to provide access to the data in the performance data repository.
